(19) United States
(12) Patent Application Publication
(10) Pub. No.: US 2001/0031399 A1
(43) Pub. Date: Oct. 18, 2001

(54) Positive active material for rechargeable lithium battery and method of preparing same

(76) Inventors: Hyun-Sook Jung, Cheonan-city (KR); Jae-Phil Cho, Cheonan-city (KR); Geun-Bae Kim, Cheonan-city (KR)

Correspondence Address: CHRISTIE, PARKER & HALE, LLP, 350 WEST COLORADO BOULEVARD, SUITE 500, PASADENA, CA, 91105, US

(21) Appl. No.: 09/775,315

(22) Filed: Jan. 31, 2001

(30) Foreign Application Priority Data
Feb. 14, 2000 (KR) 2000-6854
May 17, 2000 (KR) 2000-26267

(51) Int. Cl. H01M 4/50; H01M 4/52

(52) U.S. Cl. 429/223; 429/224; 429/231.1; 252/182.1

(57) ABSTRACT

Disclosed is a positive active material for a rechargeable lithium battery and a method of preparing the same. The positive active material includes lithium nickel manganese oxide and lithium manganese oxide. The weight ratio of the lithium manganese oxides to the lithium nickel manganese oxides is less than 1. In this method, lithium nickel cobalt oxide is mixed with lithium manganese oxides. At this time, the weight ratio of lithium manganese oxides to lithium nickel cobalt oxides is less than 1. The resulting mixture is added with a binder and then the resulting mixture is heat-treated at a low-temperature.

### CROSS REFERENCE TO RELATED APPLICATION

This application is based on application Nos. 2000-6854 and 2000- 26267 filed in the Korean Industrial Property Office on Feb. 14, 2000 and May 17, 2000, the content of which is incorporated hereinto by reference.

### BACKGROUND OF THE INVENTION

(a) Field of the Invention

The present invention relates to a positive active material for a rechargeable lithium battery and a method of preparing the same, and more particularly, to a positive active material for a rechargeable lithium battery exhibiting improved charge and discharge characteristics and thermal stability.

(b) Description of the Related Art

Rechargeable lithium batteries use a material from or into which lithium ions are deintercalated or intercalated as positive and negative active materials. Rechargeable lithium batteries produce electric energy from changes of chemical potentials of the active materials during the intercalation and deintercalation reactions of lithium ions.

For the negative active material in a rechargeable lithium battery, metallic lithium was used in the early days of development. Recently, however, carbon material which intercalate lithium ions reversibly is extensively used instead of the metallic lithium due to problems of high reactivity toward electrolyte and dendrite formation of the metallic lithium. With the use of carbon-based active materials, the potential safety problems which are present in the batteries with the metallic lithium can be prevented while achieving relatively higher energy density as well as much improved cycle life.

For the positive active material in the rechargeable lithium battery, chalcogenide compounds into or from which lithium ions are reversibly intercalated or deintercalated are used. Typical examples include cobalt-based material such as LiCoO₂, manganese-based materials such as LiMn₂O₄, or LiMnO₂, or nickel-based materials such as LiNiO₂, or LiNi₁₋ₓCoₓO₂(0<X<1).

Manganese-based materials such as LiMn₂O₄ or LiMnO₂ are less expensive and have much better thermal stability than the other materials, and much more environmentally friendly while having good charge-discharge characteristics. However, the manganese-based materials have significantly smaller capacity than the other materials. Although LiNiO₂ is relatively inexpensive and has high charge capacity, its thermal stability is rather poor causing safety problems for the rechargeable lithium batteries. The cobalt-based active material such as LiCoO₂ exhibits good electrical conductivity of 10⁻² to 1 S/cm at ambient temperature and high cell voltage and good electrochemical properties and is widely used in commercially available rechargeable lithium batteries. However, the cobalt-based active material is relatively expensive.

Recently, there are demands to reduce a Co content in the Co-based active material to reduce the cost of the positive active materials. One way of reducing the Co content is to substitute a part of the Co from LiCoO₂ with other metals forming LiₓCo_{1-y}M_{y}O₂ (0.95≦x≦1.5, 0≦y≦0.5). However, one of the problems associated with such substitutions is that the charge-discharge characteristics and thermal stability of the compound are deteriorated as the content of Co decreases (U.S. Pat. No. 4,770,960).

Another approach is that a low-cost Ni-based material is physically mixed with another low-cost Mn-based material to produce a positive active material for a rechargeable lithium battery (U.S. Pat. No. 5,429,890). However, when the resulting mixture is used for preparation of positive active material slurry, the Ni-based material and the Mn-based material are not uniformly distributed in the slurry. Such non-uniformity in the slurry resulted in a rather severe quality problem of non-uniform performance of the resultant batteries.

A mixture of LiₓNi_{y}Co_{z}MₙO₂ (M is Al, Ti, W, Cr, Mo, Mg, Ta, Si or a mixture thereof, x=0 to 1, y+z+n=about 1, n=0-0,25, one of z and n is above 0 and z/y is 0 to about ⅓) and Mn-based oxides such as LiₓMn₂₋ᵣM1ᵣO₄ (M1 is W, Ti, Cr or a mixture thereof, and r=0 to 1) are also tried (U.S. Pat. No. 5,783,333). However, the approach also included use of the rather expensive cobalt.

### SUMMARY OF THE INVENTION

It is an object of the present invention to provide a positive active material for a rechargeable lithium battery exhibiting good charge and discharge characteristics, thermal stability and high capacity.

It is another object to provide a positive active material for a rechargeable lithium battery which is low cost.

It is still another object to provide a low cost method of preparing a positive active material for a rechargeable lithium battery.

These and other objects may be achieved by a positive active material for a rechargeable lithium battery including lithium nickel manganese oxide and lithium manganese oxide. The weight ratio of the lithium manganese oxide to the lithium nickel manganese oxide is less than 1. The lithium nickel manganese oxide is LiₓNi_{1-y}Mn_{y}O_{2+z} (0<x<1.3, 0.1≦y≦0.5, and 0≦z≦0.5), and the lithium manganese oxides is Li₁₋ₓMn_{2-x′}O_{4+z} (0≦x′≦0.3, 0≦z≦0.5).

In order to achieve these objects and others, the present invention provides a method of preparing a positive active material for a rechargeable lithium battery. In this method, lithium nickel cobalt oxides is mixed with lithium manganese oxides in the weight ratio of lithium manganese oxides to lithium nickel cobalt oxides of less than 1. This mixed compound is further mixed a small amount of a binder followed by heat-treating at a low-temperature, preferably 200 to 500° C. The lithium nickel cobalt oxide is LiₓNi_{1-y-z}Co_{y}M_{z}O₂ (M is transition metal, 0<x<1.3, 0≦z≦0.5, and y+z<1), and the lithium manganese oxides is Li_{1+x′}Mn_{2-x′}O_{4+z} (0≦x′≦0.3, 0≦z≦0.5).

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a graph showing charge and discharge characteristics of a positive active material according to Examples of the present invention;

FIG. 2 is a graph showing charge and discharge characteristics of a positive active material according to Comparative Examples;

FIG. 3 a graph showing initial charge and discharge characteristics of a positive active material according to Examples of the present invention; and

FIG. 4 is a graph showing initial charge and discharge characteristics of a positive active material according to Comparative Examples.

### DETAILED DESCRIPTION OF THE INVENTION

The present invention relates to a low-cost positive active material for a rechargeable lithium battery. For this, the present invention uses no cobalt, or the small amount of cobalt. Namely, as starting materials in the present invention, either nickel manganese-based oxides and manganese-based oxide which do not contain any cobalt are used or, nickel cobalt-based oxide and manganese-based oxide which contain the reduced amount of cobalt are used.

The individual nickel manganese-based oxide or nickel cobalt-based oxide exhibits high capacity and is relatively low cost, but exhibits inferior charge and discharge characteristics and thermal stability due to their structural instability. Whereas the manganese-based oxide exhibits good charge and discharge characteristics and thermal stability, but low capacity.

One part of the present invention is based on an idea in that a two-component mixture of the nickel manganese-based oxide or nickel cobalt-based oxide, and manganese-based oxide might have a synergetic effect of each component through a compensation for the disadvantages of the individual components. For gaining the maximum synergetic effects, the ratio and choice of individual components is important, especially, when the nickel cobalt-based oxide is used.

Another part of the present invention is the method of the preparation of the positive active material.

The present invention is further illustrated below in more detail.

1) Cobalt including material

An excess amount of lithium nickel cobalt oxide is mixed with lithium manganese oxide. Namely, the weight ratio of lithium manganese oxide to lithium nickel cobalt oxide is less than 1. If the amount of the lithium nickel cobalt oxide is equal to, or is less than that of the lithium manganese oxide, the capacity is reduced. More preferably, the mixing ratio of lithium nickel cobalt oxide and lithium manganese oxide is 90:10 to 60:40% by weight.

The lithium nickel cobalt oxide is LiₓNi_{1-y-z}Co_{y}M_{z}O₂ (M is a transition metal, 0<x<1.3, 0≦z≦0.5, and y+z<1), and the lithium manganese oxides is Li_{1+x′}Mn_{2-x′}O_{4+z} (0≦x′≦0.3, 0≦z≦0.5).

The mixture is added with a small amount of binder. The amount of the binder is 0.5 to 1 wt %, preferably 0.5 to 0.8 wt % of the mixture. The binder helps the oxide particles to be mixed uniformly and bound together. Various polymer materials may be used for the binder if the material does not have an adverse effect on the electrochemical characteristics of the positive active material. An example of the binder is polyvinylidene fluoride and is not limited this.

The resulting mixture is heat-treated at a low temperature. The heat-treating is preferably performed at 200 to 500° C. If the heat-treating temperature is less than 200° C., the binder is not dissolved, whereas if the heat-treating temperature is more than 500° C., the chemical bond between the lithium nickel cobalt oxide and the lithium manganese oxide does not occur and the unwanted product may be obtained. During the heat-treatment, the binder is removed by evaporating and the chemical mixture (reactant) is obtained. At this time, the binder may be not completely removed and a trace of the binder may be remained in the chemical mixture, but it does not deteriorate the characteristics of the positive active material.

The obtained mixture is a chemical reactant of the lithium nickel cobalt oxide and the lithium manganese oxide and thus, it exhibits both advantages of the lithium nickel cobalt oxide and the lithium manganese oxide rather than disadvantages.

2) Nickel manganese oxide including material (no cobalt)

An excess amount of lithium nickel manganese oxide is mixed with lithium manganese oxide to prepare a positive active material. Namely, the weight ratio of the lithium manganese oxide to the lithium nickel manganese oxide is less than 1. If the amount of lithium nickel manganese oxide is equal to or is less than that of lithium manganese oxide, the capacity is reduced. More preferably, the mixing ratio of the lithium nickel manganese oxide and lithium manganese oxide is 90:10 to 60:40% by weight.

The lithium nickel manganese oxide may be LiₓNi_{1-y}Mn_{y}O_{2+z} (0<x<1.3, 0.1≦y≦0.5, and 0≦z≦0.5) and the lithium manganese oxides is Li_{1+x′}Mn_{2-x′}O_{4+z} (0≦x′≦0.3, 0≦z≦0.5).

The resulting positive active material of the present invention includes lithium nickel manganese oxide and lithium manganese oxide without including high-cost cobalt providing a low-cost positive active material.

A process for fabricating rechargeable lithium batteries sing the positive active material is known in the art. An exemplary method is as follows:

The positive active material of the present invention, a binder such as polyvinyl pyrrolidone, and an inert conductive agent such as acetylene black, or carbon black are mixed with an organic solvent such as N-methyl-2-pyrrolidone to prepare a positive active material slurry. The slurry is coated (cast) on a current collector such as Al-foil with a thickness of 60 to 70 μm (including the thickness of the current collector). The coated collector is dried to make a positive electrode.

A negative electrode is also fabricated by the conventional process known in the related arts, for example by coating a slurry of a negative active material on a current collector and drying. The negative active material slurry includes a negative active material, a binder such as polyvinylidene fluoride, and an inert conductive agent such as carbon black. The current collector may be Cu-foil. The negative active material may be any compound which can be used in the rechargeable lithium battery and the exemplary thereof is a carbonaceous active material such as graphite or carbon, from or into which lithium ions are deintercalated or intercalated. In the rechargeable lithium batteries, a conventional non-aqueous liquid electrolyte or polymer electrolyte may be used. For separators, porous polymer film such as polypropylene or, polyethylene may be used.

The electrolyte includes organic solvents and a lithium salt. The organic solvents may include a cyclic carbonate such as ethylene carbonate or methylene carbonate, or a linear carbonate such as dimethyl carbonate, diethyl carbonate, ethylmethyl carbonate or methylpropyl carbonate. The lithium salt is suitably one which provides a high lithium ion mobility in the electrolyte, thus giving high ionic conductivity. Examples of lithium salts may be LiPF₆, LiAsF₆, LiCF₃SO₃, LiN(CF₃SO₂)₃, LiBF₆ or LiClO₄.

The present invention is further explained in more detail with reference to the following examples.

### EXAMPLE 1

Li_{0.98}Ni_{0.82}Co_{0.18}O₂ was mixed thoroughly with Li_{1.05}Mn₂O₄ in a mortar in the weight ratio of 90:10 wt % followed by addition of a small amount of the binder (1.0% of the mixture by weight, polyvinylidene fluoride, 1.30 dl/g) and further mixing thoroughly. The mixture was heat-treated at 300° C. to prepare a positive active material for a rechargeable lithium cell.

The positive active material, a conductive agent (acetylene black, 62.5 m2/g) and a binder (polyvinylidene fluoride, 1.30 dl/g) were weighed in the weight ratio of 94:3:3 into a mixer followed by addition of an appropriate amount of a N-methyl-2-pyrrolidone solvent to prepare a positive active material slurry by mixing them thoroughly. The slurry was coated on an Al-foil for an electrode thickness of 60 μm including the thickness of the followed by drying it in an oven at 135° C. for 3 hours. The dried foil was compressed under a predetermined load to complete a positive electrode. A coin-type half-cell was fabricated in a glove box by using the positive electrode, a lithium metal counter/reference electrode, a micropores membrane separator, and an electrolyte solution of 1M _{LiPF6} in 1:1 mixture of ethylene carbonate and dimethyl carbonate.

### EXAMPLE 2

A half-cell was manufactured by the same procedure as in Example 1 except that Li_{0.98}Ni_{0.82}Co0.18O₂ was mixed with Li_{1.05}Mn₂O₄ in a mortar in the weight ratio of 80:20 wt %.

### EXAMPLE 3

A half-cell was manufactured by the same procedure as in Example 1 except that Li_{0.98}Ni_{0.82}Co_{0.18}O₂ was mixed with Li_{1.05}Mn₂O₄ in a mortar in the weight ratio of 70:30 wt %.

### Comparative Example 1

A half-cell was fabricated by the same procedure as in Example 1 except that Li_{0.98}Ni_{0.82}Co_{0.18}O₂ was mixed with Li_{1.05}Mn₂O₄ in a mortar in the weight ratio of 90:10 wt % to produce a positive active material for a rechargeable lithium battery.

### Comparative Example 2

A half-cell was fabricated by the same procedure as in Example 1 except that Li_{0.98}Ni_{0.82}Co_{0.18}O₂ was mixed with Li_{1.05}Mn₂O₄ in a mortar in the weight ratio of 80:20 wt % to produce a positive active material for a rechargeable lithium battery.

### Comparative Example 3

A half-cell was fabricated by the same procedure as in Example 1 except that Li_{0.98}Ni_{0.82}Co_{0.18}O₂ was mixed with Li_{1.05}Mn₂O₄ in a mortar in the weight ratio of 70:30 wt % to produce a positive active material for a rechargeable lithium battery.

The charge and discharge characteristics of the half-cells according to Examples 1 to 3 and Comparative Examples 1 to 3 were measured. The charge and discharge cycles were carried out once at 0.1 C rate, three times at 0.2 C, 10 times at 0.5 C and 100 times at 1 C between voltage limits of 4.3 and 30 V. The charge and discharge characteristics (discharge capacity and discharge voltage) are shown in Table 1. In Table 1, overall performance of the cells according to Examples 1 to 3 and Comparative Examples 1 to 3 was indicated as “good” or “no good”.

TABLE 1

| | Ni-Co-based | | Mind-discharge | |
|---|---|---|---|---|
| | material/Mn- | Discharge | voltage [18 | |
| | based material | capacity | mAh/g reference, | Overall |
| | [wt %] | [mAh/g] | V] | Results |
| Example 1 | 9/1 | 171 | 3.812 | Good |
| Example 2 | 8/2 | 158 | 3.881 | Good |
| Example 3 | 7/3 | 154 | 3.889 | Good |
| Comparative | 9/1 | 158 | 3.792 | No good |
| Example 1 | | | | |
| Comparative | 8/2 | 162 | 3.792 | No good |
| example 2 | | | | |
| Comparative | 7/3 | 145 | 3.839 | No good |
| example 3 | | | | |

As shown in Table 1, the discharge capacity and the mid-discharge voltage values of cells according to Examples 1 to 3 are higher than those of Comparative Examples 1 to 3.

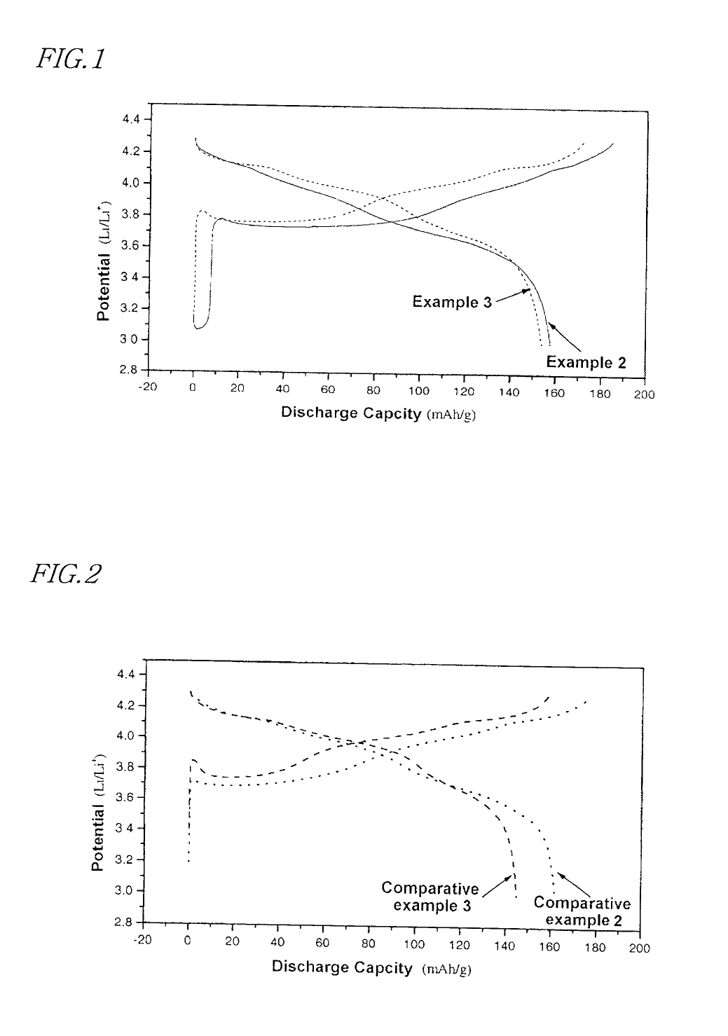

The initial charge and discharge characteristics of the cells according to Examples 2 and 3 and Comparative Examples 2 and 3 are presented in FIGS. 1 and 2, respectively. The cell according to Example 2 has comparable discharge capacity to that of the cell according to Comparative Examples 2. However, the cell according to Example 3 exhibits significantly higher capacity than the cell according to Comparative Example 3. The rather surprisingly low capacity of the cell according to Comparative Example 3 is not understood well. However, we speculate that the positive active material of Comparative Example 3 exhibits the sum of the individual characteristics of Mn-based oxide and Ni-Co-based oxide, while the positive active material according to Example 3 exhibits modified characteristics of Mn-based oxide and Ni-Co-based oxide, giving a synergy between these two oxides.

The present invention can provides with a low-cost positive active material which has significantly improved electrical performance as well as thermal stability.

### EXAMPLE 4

Li_{1.03}Ni_{0.8}Mn_{0.2}O₂ was mixed with LiMn₂O₄ in a mortar in the ratio of 90:10 wt %. The mixture, a conductive agent (acetylene black, 62.5 m2/g) and a binder (polyvinylidene fluoride, 1.30 dl/g) were weighed in the weight ratio of 94:3:3 into a mixer followed by addition of an appropriate amount of a N-methyl-2-pyrrolidone solvent to prepare a positive active material slurry by mixng them thoroughly. The slurry was coated on an Al-foil for an electrode thickness of 60 μm including the thickness of the foil followed by drying it in an oven at 135° C. for 3 hours. The dried foil was compressed under a predetermined load to complete a positive electrode. A coin-type half-cell was fabricated in a glove box by using the positive electrode, a lithium metal counter reference electrode, a microporous membrane separator, and an electrolyte solution of 1M LiPF₆ in 1:1 mixture of ethylene carbonate and dimethyl carbonate.

### EXAMPLE 5

A half-cell was fabricated by the same procedure as in Example 4 except that Li_{1.03}Ni_{0.8}Mn_{0.2}O₂ was mixed with LiMn₂O₄ in the weight ratio of 80:20 wt %.

### EXAMPLE 6

A half-cell was fabricated by the same procedure as in Example 4 except that Li_{1.03}Ni_{0.8}Mn_{0.2}O₂, was mixed with LiMn₂O₄ in the weight ratio of 70:30 wt %.

### EXAMPLE 7

A half-cell was fabricated by the same procedure as in Example 4 except that Li_{1.03}Ni_{0.8}Mn_{0.2}O₂ was mixed with LiMn₂O₄ in the weight ratio of 60:40 wt %.

### Comparative Example 4

A half-cell was fabricated by the same procedure as in Example 4 except that Li_{1.03}Ni_{0.8}Co_{0.2}O₂ instead of Li_{1.03}Ni_{0.8}Mn_{0.2}O₂ was mixed with LiMn₂O₄ in the weight ratio of 90:10 wt %.

### Comparative Example 5

A half-cell was manufactured by the same procedure as in Example 4 except that Li_{1.03}Ni_{0.8}Co_{0.2}O₂ instead of Li_{1.03}Ni_{0.8}Mn_{0.2}O₂ was mixed with LiMn₂O₄ in the weight ratio of 80:20 wt %.

### Comparative Example 6

A half-cell was manufactured by the same procedure as in Example 4 except that Li_{1.03}Ni_{0.8}Co_{0.2}O₂ instead of Li_{1.03}Ni_{0.8}Mn_{0.2}O₂ was mixed with LiMn₂O₄ in the weight ratio of 70:30 wt %.

### Comparative Example 7

A half-cell was manufactured by the same procedure as in Example 4 except that Li_{1.03}Ni_{0.8}Co_{0.2}O₂ was mixed with LiMn₂O₄ in the weight ratio of 60:40 wt %.

The charge and discharge characteristics of the half-cells according to Examples 5 to 7 and Comparative Examples 5 to 7 were measured. The charge and discharge cycles were carried out once at 0.1 C, three times at 0.2 C, 10 times at 0.5 C and 100 times at 1 C between voltage limits of 4.3 and 3.0 V. The charge and discharge characteristics (discharge capacity and discharge voltage) are shown in Table 2.

For thermal stability test of the charged positive active material, the cells according to Examples 5 to 7 and Comparative Examples 5 to 7 were fully charged with the cut-off voltage of 4.3 V, the positive electrode was removed from the cell, and it was dried for a day. Differential scanning calorimetry (DSC) measurements were carried out in order to evaluate the thermal stability of the positive active materials according to Examples 5 to 7 and Comparative examples 5 to 7. The thermal decomposition temperature (oxygen release temperature) is shown in Table 2. The thermal decomposition temperature (oxygen decomposition temperature) shown in Table 2 refers to a temperature at which the bond between metal and oxygen in the charged positive active material becomes unstable. The released oxygen may react with the electrolyte in the cell and may cause a safety problem. The temperature at which oxygen starts to be released and the quantity of heat evolved when oxygen is released is critically important for the stability of the cell.

In Table 2, overall performance of the cells according to Examples 4 to 7 and Comparative Examples 4 to 7 were indicated as “good” and “no good”.

TABLE 2

| | | | | | Thermal | |
|---|---|---|---|---|---|---|
| | | | | Mid- | decom- | |
| | | | Dis- | discharge | position | |
| | | | charge | voltage | tempera- | |
| | Ni-Mn/ | Ni-Co/ | capacity | [18 mAh/g | ture from | |
| | Mn | Mn | [mAh/ | reference, | DSC peak | Overall |
| | [wt %] | [wt %] | g] | V] | [° C.] | result |
| Exam- | 9/1 | | 184 | 3.84 | 213 | Good |
| ple 4 | | | | | | |
| Exam- | 8/2 | | 167 | 3.906 | 210 | Good |
| ple 5 | | | | | | |
| Exam- | 7/3 | | 156 | 3.94 | 217 | Good |
| ple 6 | | | | | | |
| Exam- | 6/4 | | 152 | 3.97 | 205 | Good |
| ple 7 | | | | | | |
| Compara- | | 9/1 | 171 | 3.79 | 110 | No |
| tive | | | | | | good |
| example 4 | | | | | | |
| Compara- | | 8/2 | 172 | 3.82 | 120 | No |
| tive | | | | | | good |
| example 5 | | | | | | |
| Compara- | | 7/3 | 162 | 3.889 | 150 | No |
| tive | | | | | | good |
| example 6 | | | | | | |
| Compara- | | 6/4 | 145 | 3.91 | 205 | No |
| tive | | | | | | good |
| example 7 | | | | | | |

As shown in Table 2, the cells using the positive active materials according to Examples 4 to 7 have similar or slightly lower capacity, but exhibits better discharge characteristics than Comparative examples 4 to 7. In addition, the thermal decomposition temperature of the cells according to Examples 4 to 7 is higher than that of Comparative Examples 4 to 7. The results indicate that the cells of Examples 4 to 7 will have superior thermal stability than those of Comparative Examples 4 to 7.

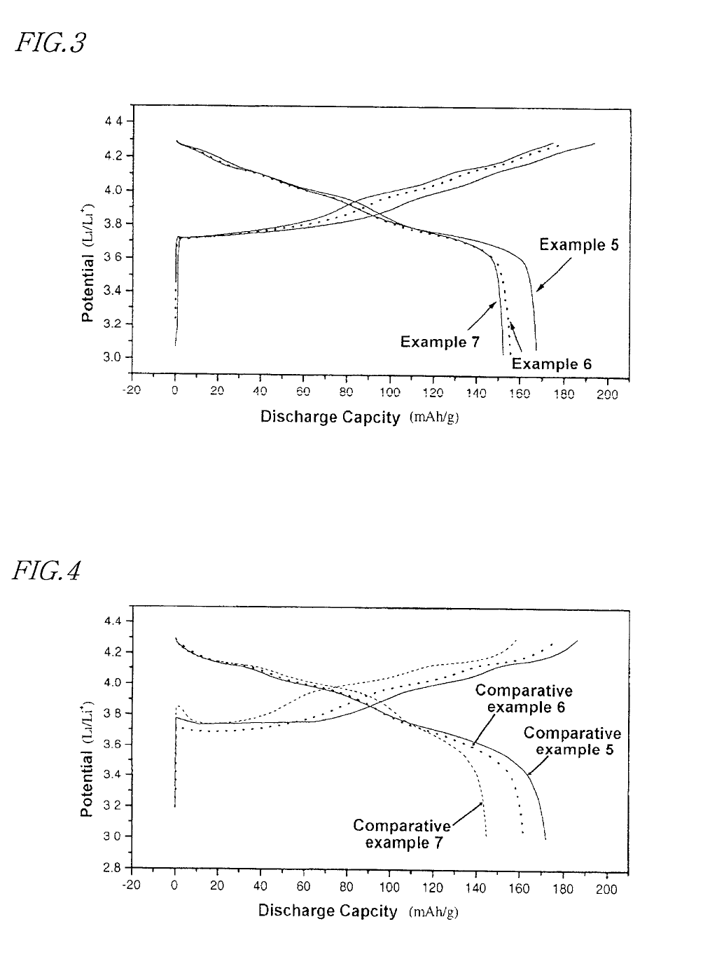

The initial charge and discharge characteristics of the cells according to Examples 5 to 7 and Comparative Examples 5 to 7 are presented in FIGS. 3 and 4, respectively. The cell according to Examples 5 and 6 show comparable discharge capacity to that of the cell according to Comparative Examples 5 and 6, although the cell according to Example 7 exhibits significantly capacity than the cell according to Comparative Example 7.

Overall, the positive active material of the present invention without Co exhibits comparable electrical performance in the battery to that of the cobalt including active material.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A positive active material for a rechargeable lithium battery comprising:
lithium nickel manganese oxides; and
lithium manganese oxides,
wherein a weight ratio of the lithium manganese oxides to the lithium nickel manganese oxides is less than 1.

2. The positive active material of claim 1 wherein the lithium nickel manganese oxides is LiₓNi_{1-y}Mn_{y}O_{2+z} (0<x<1.3, and 0.1≦y≦0.5), 0≦z≦0.5).

3. The positive active material of claim 1 wherein the lithium manganese oxides is Li_{1+x′}Mn_{2-x′}O_{4+z} (0≦x′≦0.3, and 0≦z≦0.5).

4. The positive active material of claim 1 wherein the mixing ratio of the lithium nickel manganese oxides and lithium manganese oxides is 90 to 60:10 to 40 wt %.

5. A method of preparing a positive active material for a rechargeable lithium battery, comprising the steps of:
mixing lithium nickel cobalt oxide with lithium manganese oxide, the weight ratio of lithium manganese oxide to lithium nickel cobalt oxide being less than 1;
adding a binder to the mixture; and
heat-treating the resulting mixture at a low-temperature.

6. The method of claim 5 wherein the lithium nickel cobalt oxides is LiₓNi_{1-y-z}Co_{y}M_{z}O₂ (M is transition metal, 0<x<1.3, 0≦z≦0.5, and y+z<1).

7. The method of claim 5 wherein the lithium manganese oxides is Li_{1+x′}Mn_{2-x′}O_{4+z} (0≦x′≦0.3, 0 ≦z≦0.5).

8. The method of claim 5 wherein the weight ratio of the lithium nickel cobalt oxides and lithium manganese oxides is 90 to 60:10 to 40 wt %.

9. The method of claim 5 wherein the heating step is performed at 200 to 500° C.

10. A positive active material for a rechargeable lithium battery produced by mixing lithium nickel cobalt oxides with lithium manganese oxides, the weight ratio of lithium manganese oxides to lithium nickel cobalt oxides being less than 1;
adding a binder to the mixture; and
heat-treating the resulting mixture at a low-temperature.
